(19) United States
(12) Patent Application Publication
(10) Pub. No.: US 2026/0163458 A1
(43) Pub. Date: Jun. 11, 2026

(54) METHOD FOR PRODUCING A COIL WINDING

(71) Applicant: Schaeffler Technologies AG & Co. KG, Herzogenaurach (DE)

(72) Inventors: Alexander Moser, Buhl (DE); Florian Koss, Lichtenau (DE); Bernd Hammel, Altenstadt (DE)

(73) Assignee: Schaeffler Technologies AG & Co. KG, Herzogenaurach (DE)

(21) Appl. No.: 18/686,107

(22) PCT Filed: Jul. 21, 2022
(86) PCT No.: PCT/DE2022/100530

§ 371 Date: Feb. 23, 2024

(30) Foreign Application Priority Data
Aug. 26, 2021 (DE) 10 2021 122 115.3

(51) Int. Cl. H02K 15/048

(52) U.S. Cl. CPC H02K 15/048

(57) ABSTRACT

A method for producing a coil winding which is intended for drawing into a stator, a rotor or a drawing-in tool, is of a wave-like form, includes opposing layers and has a plurality of individual wires with wire webs and end windings, and the wire webs are respectively arranged between two successive end windings along the length of the individual wires, and the end windings form lateral regions of the coil winding, the method including pressing the opposing layers of the coil winding by means of a pressing pressure commencing in the one middle region of the wire webs and continuing or migrating outwards to reach into the region of the end windings.

### CROSS-REFERENCE TO RELATED APPLICATIONS

This application is the U.S. National Phase of PCT Appln. No. PCT/DE2022/100530, filed Jul. 21, 2022, which claims the benefit of German Patent Appln. No. 102021122115.3, filed Aug. 26, 2021, the entire disclosures of which are incorporated by reference herein.

### TECHNICAL FIELD

The disclosure relates to a method for producing a wave-like coil winding intended for drawing into a stator, a rotor or into a drawing-in tool.

### BACKGROUND

Coil windings can be made by winding individual wires in wire packs around a winding former. If the individual wires have a rectangular cross section, then they are called flat wire windings.

The following describes one way in which a coil winding can be produced using a winding former. Such a method is known, for example, from DE 10 2015 120 661 A1.

The wires are applied to a flat, elongated, sword-like winding former. The winding former can be rotated along its longitudinal axis and the wire pack is fed perpendicular to the longitudinal axis. Before the former is rotated by 180°, the wire pack applied to the former undergoes an axial offset along the longitudinal axis so that an inclined wire section is formed. The winding former is rotated so that this inclined wire section is formed around one edge of the former and continues on the rear side. The wire pack is then axially offset again so that it is oriented perpendicular to the longitudinal axis of the winding former. The inclined wire sections form end windings which, when mounted onto the winding former, reach from one side of the winding former to the other side of the winding former. Wire webs are formed on both sides between the end windings and consist of the wire sections of the wire pack that extend perpendicular to the winding former. In this way, the wire sections can be used to create a continuous axial offset of the individual wires along the longitudinal axis. The offset can be, for example, half the width of the wire pack. By rotating the winding former, the wires overlap with respect to the longitudinal axis with a corresponding amount of offset.

The result is a flat, wave-like coil winding, which is also referred to as a wave winding and has roof-like end windings which are arranged in the course of the individual wires of the wave winding between two straight wire webs. During drawing into a rotor or stator with a cylindrical rotor or stator body, the wave winding with the individual wires lying one above the other is drawn in the region of the webs into grooves and the end windings protrude axially beyond the rotor or stator body and form the offset of the individual wires via different grooves. As a rule, the entire coil winding produced is compressed flat so that overlapping wires are as close to one another as possible.

By means of a coil winding produced using the method described above, coils of a plurality of electrical circuits can be introduced into a stator or rotor body at once so that, for example, three-phase operation of an electric motor is possible. Therefore, the wire packs used preferably have a number of individual wires in a multiple of three. But other constellations are also conceivable. It is also conceivable for the wave winding produced to not be drawn directly into a rotor or stator, but first into a drawing-in tool, which ultimately transfers the wave winding into a rotor or stator body.

Owing to the method described above, particularly when using cross-sectionally rectangular wires for flat wire windings, a strong plastic deformation of the wires is to be expected when the individual wires are bent around the winding former, namely when the winding former is rotated and the inclined regions around an edge of the winding former are shaped and then compressed flat. Depending on the edge design of the winding former, more or less high torsion initially occurs in the cross-sectionally rectangular wires, which on the one hand takes up space and on the other hand can damage an insulation layer present on the wires. The individual wires are usually made of copper, which is much more ductile than an applied insulation layer made of insulating varnish. If the wires are excessively deformed, there is a risk of the insulation layer flaking off and forming a defect in the coil winding. Even one defect in a coil winding can lead to the entire component being rejected. During compression to achieve the smallest possible spatial extension of the end windings of a coil winding inserted into a rotor, stator or a drawing-in tool, the edges of a wire point can also press into an adjacent wire and destroy the insulation layer.

### SUMMARY

The object of the disclosure is to provide a method that eliminates the disadvantages mentioned and in particular produces a space-efficient and continuously insulated coil winding.

The aforesaid object is achieved according to claim 1 with embodiments according to any one of claims 2 to 10.

For a method for producing a wave-like coil winding intended for drawing into a stator, a rotor or into a drawing-in tool and consisting of opposing layers, which consists of a plurality of individual wires with wire webs and end windings, and the wire webs are arranged in each case in the course of the individual wires between two successive end windings and the end windings form lateral regions of the coil winding, a compressing of the opposing layers of the coil winding is provided by means of a pressing pressure that begins in a middle region of the wire webs and then expands or migrates outwards into the region of the end windings.

The process referred to here as “compressing” does not generally mean that it results in a deformation in the sense of a change in the thickness of the individual wires. Rather, the term “compressing” refers here to a pure deformation of the wires in the sense of an orientation of the winding, which aims to make the winding produced flatter and not the individual wires. The compressing can be carried out by pressing the individual wires from a direction perpendicular to the coil winding, or by rolling out the coil winding using a roller. The term “rolling” mentioned below, unlike for example in sheet metal production, should also not be understood to mean that this results in a deformation in the sense of a change in the thickness of the individual wires, but rather in an orientation of the wires.

By compressing the opposing layers of the coil winding by means of a pressing pressure that begins in a middle region of the wire webs and then expands or migrates outwards into the region of the end windings, there is the advantage, particularly when using cross-sectionally rectangular wires, that uncontrolled plastic deformation of the individual wires is avoided. Compared to simultaneous compressing of the entire section extending from the region of the wire webs to the region of the end windings, such aligning or straightening does not take place for the entire wire section to be formed at the same time, as a result of which stresses can build up in the wire, but rather gradually through incremental or continuous compressing by means of the expanding or migrating pressing pressure. The compressing takes place from the region of the wire webs, i.e. outwards from a central region of the coil winding, i.e. into the region of the end windings. The contact point at which the pressing pressure is exerted migrates from the region of the wire webs into the region of the end windings. It is possible for the pressing pressure to be maintained at points where it has already been exerted during the movement in the direction of the end windings. Alternatively, it is also possible for the pressing pressure to migrate from the region of the wire webs to the region of the end windings. The movement of the pressing pressure can be incremental or continuous.

According to one embodiment of the disclosure, it is possible for at least one compressing tool to be provided with a plurality of compressing sections for the incremental compression of the coil winding, with the compressing sections pressing the individual wires one after the other. The pressing pressure is produced by the compressing sections. In this case, the compressing sections are moved in temporally successive sections from the region of the wire webs in the direction of the end windings onto the coil winding in order to bring about the desired change in thickness of the coil winding. Thus, sections of the coil winding are compressed one after the other from the region of the wire webs by means of the respective compressing sections.

According to one embodiment of the disclosure, at least one roller is provided for continuously compressing the coil winding, which rolls the individual wires. This can be done as an alternative or in addition to the compressing described above using the compressing tool. For this purpose, two rollers can be used which roll the coil winding synchronously or one roller can be used which, starting from the region of the wire webs, rolls once in the direction of one edge of the coil winding with some end windings and compresses once in the direction of the other edge with the other end windings. In one embodiment it is possible for the coil winding to be partially rolled. In this case, not all of the wound wires are rolled simultaneously over the entire length of the coil winding, but only a number of the wires in relation to the axial direction. In this way, the device required for compressing or rolling can be made more compact and the individual wires or the selection of the individual wires can be compressed or rolled in a targeted manner. For this purpose, the roller is preferably placed on the coil winding in the region of the wire webs and moved in contact with the coil winding in the direction of the end windings.

According to a further embodiment of the disclosure, it is possible for the individual wires to be compressed on both sides of the coil winding with two opposite rollers. In this way, the opposite rollers provide a counter-support for the formation of the coil winding, which otherwise has to be provided by a flat base.

In one embodiment of the disclosure, it is possible for the coil winding to be wound on a one-part or multi-part winding former before compressing. Winding the coil winding on the winding former is advantageous because the winding former provides a structural counter-support for further deformation steps in the sense of adapting to the winding former cross section. Furthermore, removal and transferring of the wound coil winding from the winding former to another former can be avoided, which on the one hand can have a positive effect on cycle times and on the other hand prevents other damage caused by the mounting and removal of the individual wires. A multi-part winding former can, for example, be designed in such a way that the coil winding is supported in the region of the end winding tips formed, for example by round rods on which the coil winding is wound.

According to a further embodiment of the disclosure, it is possible for the coil winding to be mounted on a one-part or multi-part former before compressing. This is advantageous if molding onto the winding former is not possible during the process or if unfinished coil windings, i.e. not yet formed in the region of the end windings, are to be reused. Depending on the application, it is possible that the rolling for coil windings that are otherwise produced using the same winding process has to be carried out with different parameters and possibly on different formers. A multi-part former can, for example, be designed in such a way that the coil winding is supported in the region of the end winding tips formed, for example by round rods on which the coil winding is wound.

According to a further development of the disclosure, it is possible for the former and/or the winding former to have a droplet shape laterally in cross section. The result of this is that the coil winding mounted on the former and/or winding former replicates this droplet shape and reproduces a bulge desired for compressing or rolling in the region of the end windings or end winding tips. Alternatively, other shapes with a laterally enlarged cross section, such as a bone shape or lateral bulges on an inherently flat former, can also be used as conceivable shapes. This reduces torsion in the region of the end winding tips when winding on the former, while the shape of the coil winding, which results from the increased lateral cross section of the former or winding former, is expelled outwards by compressing or rolling. The end winding tips are the regions in which the individual wires are bent from one side of the winding former to the other side of the winding former during winding. This embodiment is also conceivable for a multi-part former.

According to a further embodiment of the disclosure, it is possible for the individual wires to be pressed against the winding former and/or the former in the region of the end windings before the individual wires are compressed or rolled. By pressing, the above-described molding by compressing or rolling using the roller or the compressing tool is not to be expected, but rather any tensions that are in the region of the wire webs and/or in the transition region between wire webs and end windings but not in the region of the end winding tips are eliminated. In a further development of the disclosure, it is possible for the pressing to take place before compressing or rolling by means of a pressing device which has a negative form of the former and/or winding former in the region of the end windings. The negative form of the pressing device prevents torsion in the region of the end winding tips from being caused by the pressing after the coil winding has been compressed or rolled.

According to a further embodiment of the method, the at least two individual wires to be compressed/rolled are fixed by means of a fixing device before compressing or rolling of the individual wires. This is advantageous because in this way an axial or lateral displacement of the coil winding during rolling is effectively avoided.

According to a further embodiment of the disclosure, it is possible for the roller to have a defined distance from a base or from a symmetrically guided second roller on the opposite side of the coil winding, at least during the rolling of the wire webs. By maintaining a defined distance, the rolling process can be carried out in such a way that the desired molding onto the base takes place without the individual wires being shaped or twisted too much, which would damage the insulation of the wires.

According to a further development of the disclosure, it is possible for the distance during rolling to be constant or to increase in the direction of the end windings. In this way, deformation can take place up to the end windings and, in a preferred embodiment, rolling cannot take place beyond the end winding tips. This also contributes to a transition of an end winding from one side of the coil winding to the other side that preserves the insulation of the wires.

### BRIEF DESCRIPTION OF THE DRAWINGS

Further features, details and advantages of the disclosure result from the wording of the claims and from the following description of exemplary embodiments based on the drawings.

In the drawings:

FIG. 1: shows schematically and in detail an individual wire of a coil winding produced on a winding former according to the prior art in a sectional view and in a top view;

FIGS. 2A-C: show an embodiment of the method according to the disclosure using an individual wire of a coil winding in a sectional view and in a top view;

FIG. 2D: shows a variant of the method;

FIGS. 3A-B: show a variant of the method in which the coil winding is compressed using a compressing tool.

In the following, the same reference signs are used to identify the same elements for all the drawings, unless otherwise stated.

### DETAILED DESCRIPTION

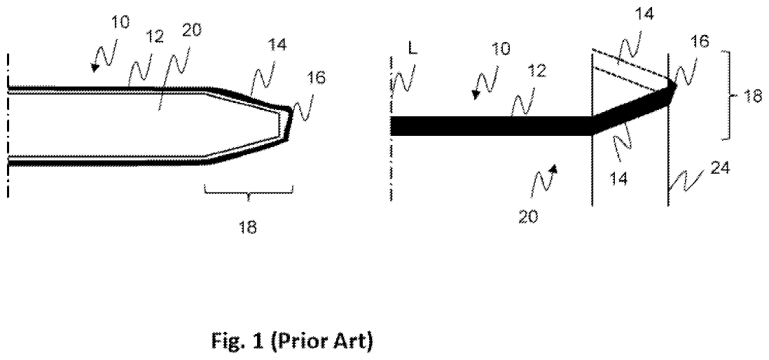

FIG. 1 shows a sectional view and a top view of a substantially cross-sectionally rectangular individual wire 10 of a wire pack which has been wound around a winding former 20 and axially offset on the winding former 20 in order to produce the end windings 18 on both sides using a method according to the prior art. For the sake of simplicity, only a single individual wire 10 is shown here as a representative of a large number of individual wires and only half of the winding former 20 or former 22 is shown.

The end windings 10 form the transition between the one side of the winding former 20 and the other side, with the end winding tip 16 lying in the region of an edge 24 of the winding former 20. The individual wires 10 are applied substantially perpendicular with respect to the winding former 20 and form wire webs 12 there. An axial offset of the individual wires 10 along the longitudinal axis L of the winding former 20 causes the formation of inclined wire sections 14. By rotating the winding former 20 about its longitudinal axis L and due to the axial offset along the winding former 20, a coil winding with end windings 18 is formed in the axial direction, with the coil winding being wound around the winding former 20. In the region of end winding tips 18 there is torsion in the individual wire 10. The torsion results, on the one hand, from wrapping the winding former 20 with the beveled region 14 of the individual wires, which forms the end winding 18, around the edge 24 of the winding former 20 and, on the other hand, from pressing the individual wires 10 onto the winding former 20.

The pressing is necessary in order to optimize the space required for the coil winding and to align the individual wires 10 of the coil winding with respect to one another in such a way that they can be inserted into grooves of a stator, rotor or drawing-in tool. By winding the individual wires 10 per se, direct contact with the winding former 20 is often not achieved due to their inherent rigidity/elasticity. In a subsequent step, the coil winding produced in this way is removed from the winding former 20 and the sections of the individual wires 10 on both sides are compressed together so that at least the wire webs 12 lie one above the other. This further increases the undesirable plastic deformation in the end winding tips 16.

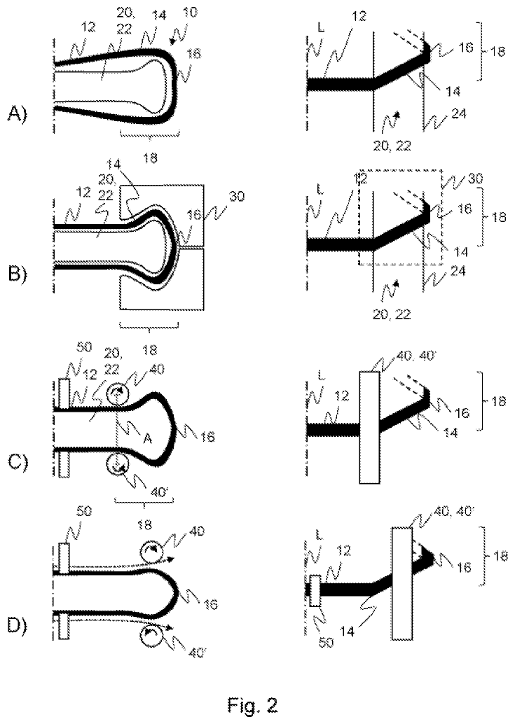

In FIG. 2A to D, embodiments of the method according to the disclosure are shown schematically once in a sectional view and once in a top view using an individual wire 10 of the coil winding.

FIG. 2A shows how an individual wire 10 is formed on a winding former 20 or former 22 used for the method so as to form the wire webs 12 arranged substantially perpendicular to the longitudinal axis L of the winding former 20 or former 22 and the inclined wire sections 14 which form the end windings 18. Here, as an example, an individual wire 10 of a wire pack is shown, which consists of a plurality of parallel individual wires 10, which are simultaneously wound around the winding former 20. In this exemplary embodiment, the individual wire 10 is wound onto a winding former 20, which has a droplet or bone shape in cross section on the sides. It can be seen that the individual wires do not necessarily have to rest on the winding former 20 after being wound onto the winding former 20.

FIG. 2B therefore shows a pressing step in which the individual wires 10 of the coil winding are pressed onto the winding former 20 by means of a pressing device 30. The pressing device 30 has the negative form of the winding former 20. The pressing step according to FIG. 2B may be optional and does not necessarily have to precede the subsequent deformation.

FIG. 2C shows the method step in which the coil winding is pressed by means of a movement beginning in the region of the wire webs 12 and reaching into the region of the end windings 18 by means of rollers 40, 40′ placed on the coil winding. In this exemplary embodiment with the rollers, the compressing is carried out by the rollers 40, 40′. The coil winding is removed from the winding former 20 or former 22 (see FIGS. 2A to 2B). The rollers 40, 40′ are placed on the coil winding in the region of the wire webs 12 and moved in the direction of the end windings 18, wherein they roll out the individual wires 10 of the coil winding outwards. In this exemplary embodiment, two rollers 40, 40′ are used, which are moved simultaneously and are arranged on both sides of the coil winding and are brought into contact with the layer of the coil winding. The rollers have a constant distance. In this embodiment it is possible for the individual wire 10 preferably to be fixed in the region of the wire web 12 by means of a fixing device 50.

FIG. 2D shows a variant of the rolling in which the rollers 40, 40′ are guided at a distance A that increases outwards to further reduce torsion of the individual wires 10 in the region of the end winding tips 16.

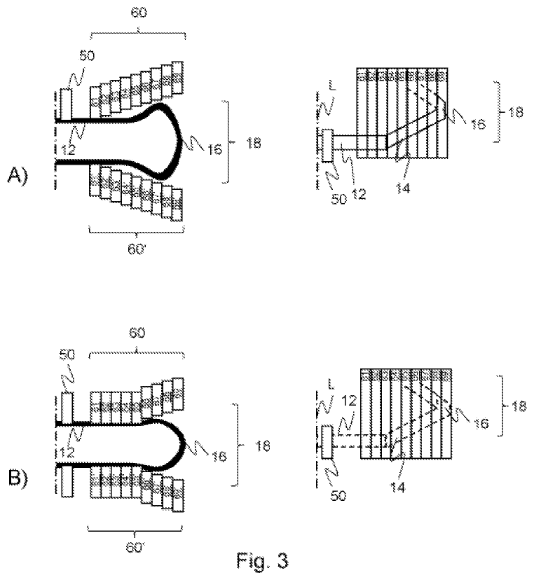

FIG. 3 shows a variant of the method in which the compressing is not carried out by means of the rollers used for the exemplary embodiment according to FIG. 2C) to D), but by means of a compressing tool 60.

The method in this embodiment is carried out analogously to FIG. 2 up to and including the fixation of the individual wires 10 (FIG. 2B). The coil winding is then compressed using a compressing tool 60 with a plurality of compressing sections 61-69, 61′-69′. In this exemplary embodiment, the compressing device 60 is brought to the coil winding from both sides. The coil winding is then compressed from the region of the wire webs 12 in the direction of the end winding tips 16. The compressing here is not a continuous movement, as described above, for example, for rolling by means of the rollers, but is carried out in sections or steps by the compressing sections 61-69, 61′-69′. The fact that a plurality of compressing sections 61-69, 61′-69′ are used results in a comparable effect in terms of the avoidance of torsion during the change in thickness of the coil winding.

All of the features and advantages resulting from the claims, description and drawings, including structural details, spatial arrangements and method steps, may be essential to the disclosure either alone or in various combinations.

For example, in a further conceivable embodiment, it is also possible for the coil winding to be produced on a winding former 20 before the method and then mounted on a former 22 to carry out some of the steps described above, such as pressing. In this case, the former 22 can have a droplet or bone shape laterally in cross section, or a multi-part former is used which has the coil winding in the region of the end windings 18 and has a larger cross section compared to the region on which the wire webs 12 are arranged. Rolling can occur on both sides of the coil winding or on one side. It is also conceivable for a roller 40, 40′ to be used to roll both end windings 18 (only one side shown here) on one side of the coil winding or for two opposite rollers 40, 40′ to roll the end windings 18 on both sides of the coil winding at the same time. It can also be conceivable for the compressing tool 60 to only be brought to the coil winding from one side and for the change in thickness of the coil winding to occur according to the method described above using the compressing tool 60 by pressing the individual wires 10 against a base.

### LIST OF REFERENCE SIGNS

10 Individual wire
12 Wire web
14 Inclined wire sections
16 End winding tip
18 End windings
s20 Winding former
22 Former
24 Edge
30 Pressing device
40, 40′ Rollers
50 Fixing device
60 Compressing tool
61-69; 61′-69′ Compressing section
L longitudinal axis
A Distance

1. A method for producing a wave-like coil winding for drawing into a stator, a rotor or into a drawing-in tool, the coil winding including opposing layers, which coil winding has a plurality of individual wires with wire webs and end windings, and the wire webs of the individual wires are arranged in each case between two successive end windings and the end windings form lateral regions of the coil winding, the method comprising:
compressing the opposing layers of the coil winding with a pressing pressure beginning in a middle region of the wire webs and continuing outwards into a region of the end windings,
wherein the coil winding is wound or mounted on a former before compressing,
and wherein the former has a droplet shape laterally in cross section.

2. The method according to claim 1, wherein at least one compressing tool with a plurality of compressing sections is provided for incremental compressing of the coil winding, wherein the compressing sections press the individual wires one after the other.

3. The method according to claim 1, wherein at least one roller is provided for continuously compressing the coil winding, which roller rolls the individual wires.

4. The method according to claim 1, wherein before the individual wires are compressed, the individual wires are pressed against the former in the region of the end windings.

5. The method according to claim 4, wherein the pressing takes place before compressing with a pressing device, which has a negative form of the former in the region of the end windings.

6. The method according to claim 1, wherein, before the individual wires are compressed, fixing at least two individual wires to be compressed with a fixing device.

7. The method according to claim 3, wherein the roller has a defined distance (A) from a base or from a symmetrically guided second roller on an opposite side of the coil winding at least during the rolling of the wire webs.

8. The method according to claim 7, wherein the distance (A) during rolling is constant or increases in the direction of the end windings.

9. A method for producing a wave-like coil winding for drawing into a stator, a rotor or into a drawing-in tool, the coil winding including opposing layers, which coil winding has a plurality of individual wires with wire webs and end windings, and the wire webs of the individual wires are arranged in each case between two successive end windings and the end windings form lateral regions of the coil winding, the method comprising:
compressing the opposing layers of the coil winding with a pressing pressure beginning in a middle region of the wire webs and continuing outwards into a region of the end windings,
wherein the coil winding is wound or mounted on a one-part or multi-part winding former before compressing,
and
wherein the one-part or multi-part winding former has a droplet shape laterally in cross section.

10. The method according to claim 9, wherein at least one compressing tool with a plurality of compressing sections is provided for incremental compressing of the coil winding, wherein the compressing sections press the individual wires one after the other.

11. The method according to claim 9, wherein at least one roller is provided for continuously compressing the coil winding, which roller rolls the individual wires.

12. The method according to claim 9, wherein before the individual wires are compressed, the individual wires are pressed against the one-part or multi-part winding former in the region of the end windings.

13. The method according to claim 12, wherein the pressing takes place before compressing with a pressing device, which has a negative form of the former in the region of the end windings.

14. The method according to claim 9, wherein, before the individual wires are compressed, fixing at least two individual wires to be compressed with a fixing device.

15. The method according to claim 11, wherein the roller has a defined distance (A) from a base or from a symmetrically guided second roller on an opposite side of the coil winding at least during the rolling of the wire webs.

16. The method according to claim 15, wherein the distance (A) during rolling is constant or increases in a direction of the end windings.
